(19) United States
(12) Patent Application Publication
(10) Pub. No.: US 2016/0137039 A1
(43) Pub. Date: May 19, 2016

(54) INSULATOR FOR ELONGATE MEMBER

(71) Applicant: GM GLOBAL TECHNOLOGY OPERATIONS LLC, DETROIT, MI (US)

(72) Inventors: Bruno A. Ferrus, Sao Bernardo do Campo (BR); Carlos A. Lopes, Sao Paulo (BR)

(21) Appl. No.: 14/547,522

(22) Filed: Nov. 19, 2014

(51) Int. Cl. B60J 5/04

(52) U.S. Cl. CPC B60J 5/0438; B60J 5/0416; B60J 5/0481

(57) ABSTRACT

An insulator for an elongated member having a first, proximate end and a second, distal end comprises a tubular member having a wall defining an opening that allows for the insertion of the elongated member and at least one slice extending from adjacent a first end of the tubular member along a portion thereof The slice is configured to allow the first and second ends to be pulled apart to increase the length of the tubular member.

### FIELD OF THE INVENTION

Exemplary embodiments of the invention are directed to insulators for elongate members and, more particularly, to highly efficient insulators and methods of manufacturing for elongate members subject to movement and vibration.

### BACKGROUND

Vehicles such as automobiles include many complex assemblies that include tightly spaced components packaged in locations that may be difficult to access following assembly. Many assemblies include elongate members that are used for various applications ranging from door latch actuators to fuel and brake lines. One commonality of most elongate members is that they are predisposed to movement or vibration at some point along their length.

When movement or vibration occurs in tightly spaced, complex assemblies, contact with other components may occur and the result can be undesirable noise, wear of components, etc. To address direct part-to-part contact between elongate members and other components, insulating sleeves or sheathing is commonly used. The sheathing may be constructed of a soft, damping material such as plastic or rubber and extends along a length of the elongate member where contact, noise and vibration is to be expected. The sheathing will typically cover the entire elongate member even though it may be sufficient to limit such insulation to less than the entire outer surface thereof. Cost and weight are negative factors with such a design.

### SUMMARY

In one exemplary embodiment a door assembly for a motor vehicle comprises a door inner panel, a trim panel, an elongated handle cable extending between the door inner panel and the trim panel and an insulating member installed over the elongated handle cable and comprising a tubular member having a wall defining an opening that allows for the insertion of the elongated handle cable and a helical slice extending from adjacent a first end of the insulating member along a portion thereof. The helical slice is configured to allow the first and second ends to be pulled apart to increase the length of the tubular member.

In another exemplary embodiment an insulator for an elongated member having a first, proximate end and a second, distal end comprises a tubular member having a wall defining an opening that allows for the insertion of the elongated member and at least one slice extending from adjacent a first end of the tubular member along a portion thereof. The slice is configured to allow the first and second ends to be pulled apart to increase the length of the tubular member.

In yet another exemplary embodiment a door assembly for a motor vehicle comprises a door inner panel, a trim panel, an elongated handle cable extending between the door inner panel and the trim panel and an insulating member installed over the elongated handle cable and comprising a tubular member having a wall defining an opening that allows for the insertion of the elongated handle cable and spaced slices extending from adjacent a first end of the insulating member along a portion thereof. The spaced slices configured to allow the first and second ends to be pulled apart to increase the length of the tubular member.

The above features and advantages, and other features and advantages of the invention, are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of a partially disassembled door panel for a vehicle embodying features of the invention;

FIG. 2 is a plan view of an elongate member and an insulating sleeve embodying features of the invention; and

FIG. 3 is a plan view of another embodiment of an elongate member and an insulating member embodying features of the invention.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term vehicle is not limited to just an automobile, truck, van or sport utility vehicle, but includes any self-propelled or towed conveyance suitable for transporting a burden.

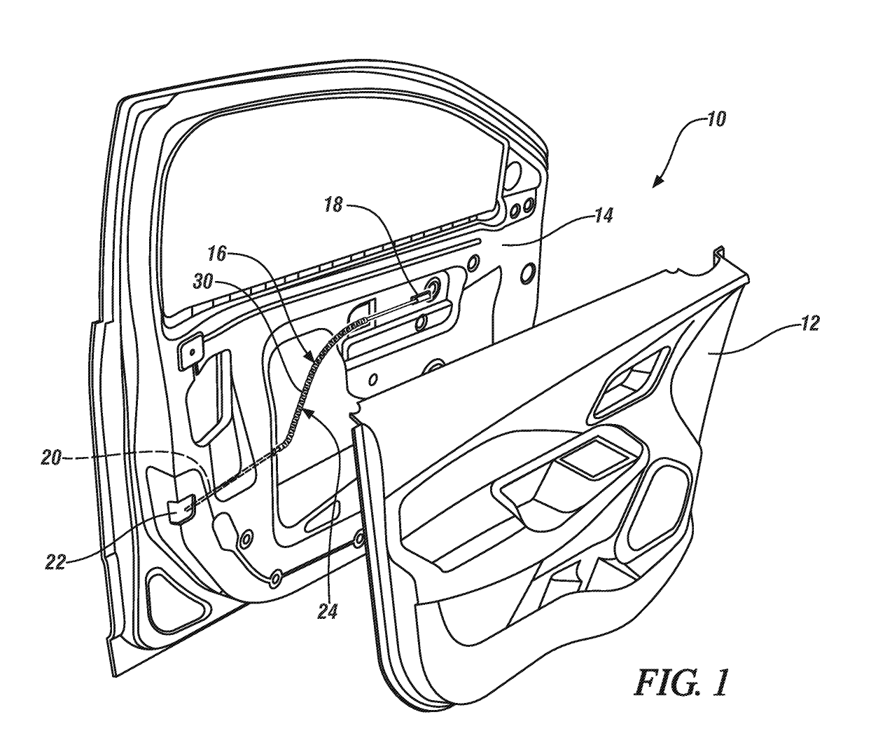

Referring to FIG. 1, a door assembly 10 for a motor vehicle is shown. The door assembly 10 is illustrated with a trim panel 12, that a passenger typically interacts with, removed and a door inner panel 14 visible. The door inner panel 14 is a part of the structural assembly of the overall door assembly 10 and supports a number of components (ex. window regulator, door latch, door lock, electric switches, speakers, rear view mirror components, side impact sensors, etc.). The components housed in or on a particular door assembly 10 will vary depending upon the trim level and application of the vehicle upon which the assembly is to be installed.

In the illustration of FIG. 1, an elongated handle cable 16 extends between the door inner panel 14 and the trim panel 12. The elongated handle cable has a first proximal end 18 that is located for engagement with a door handle (not shown) and a second distal end 20 that is located for engagement with a latch mechanism 22. Between the first end 18 and the second end 20 of the elongated handle cable 16 extends a central, elongate portion 24 that, without restraint or insulation may be free to move about between the door inner panel 14 and the trim panel 12; which is a probable source of undesirable noise.

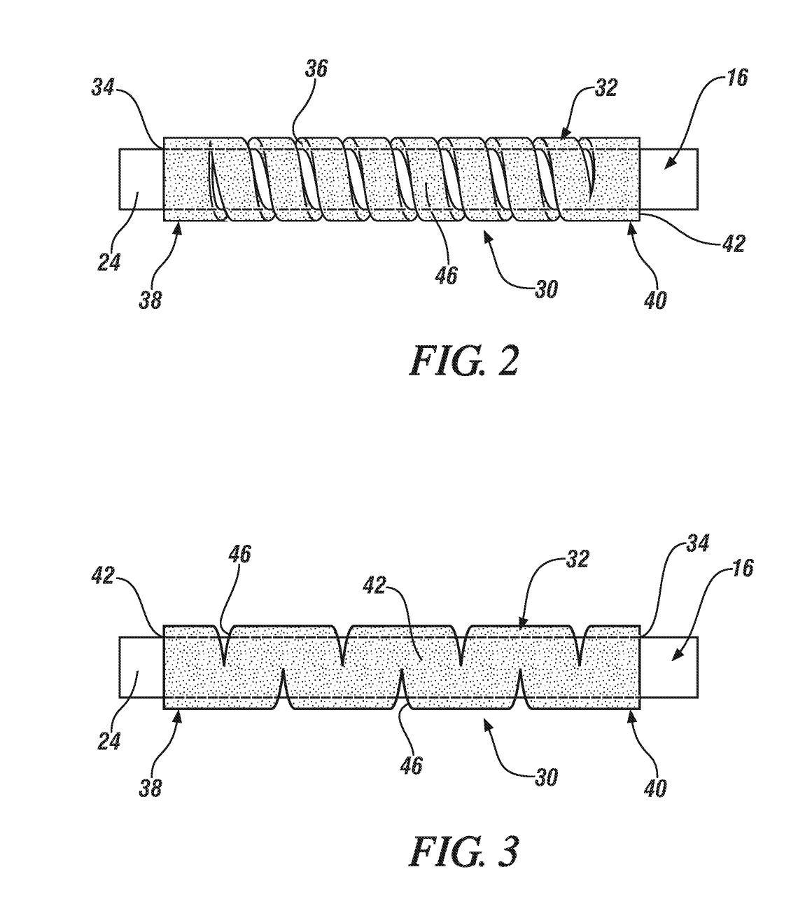

In many cases, physical restraint of the central, elongate portion 24 of an elongate member 16 may not be feasible or desirable. In an embodiment, an insulating member or sheath 30 may be installed over the elongated handle cable 16, FIG. 2. The insulating member 30 comprises a tubular member 32 defining an opening 34 that allows for the insertion of the elongated handle cable 16 and may be placed about the elongated handle cable prior to its installation into the door inner panel 14. A helical slice 36 extends from adjacent a first end 38 of the insulating member along a portion thereof. The helical slice 36 may extend the full length of the insulating member 30 to a location adjacent a second end 40, if desired. The helical slice 36 extends through the wall 42 of the tubular member 32 to the opening 34 thereby allowing the first and second ends 38, 40 to be pulled apart following installation of the insulating member 30 on the elongated handle cable 16 to increase the length of the member and, consequently, increase its insulating coverage on the elongated member. In an embodiment, the increase in length may be greater than 2 times the original length. In another embodiment, the increase in length may be greater than 2.5 times the original length.

As the ends 38, 40 of the tubular member 32 of the insulating member 30 are drawn apart, the diameter of the opening 34 may be reduced about the elongated handle cable 16 thereby ensuring a snug fit thereabout and preventing the insulating member 30 from returning to its original configuration. Additionally, the first and second ends 38, 40 may be fixed in position following elongation using mechanical fasteners (not shown) or an adhesive.

Referring to FIG. 3 in another embodiment, the insulating member 30 comprises a tubular member 32 defining an opening 34 that allows for the insertion of the elongated handle cable 16 and may be placed about the elongated handle cable prior to its installation into the door inner panel 14. Spaced slices 46 extend from adjacent a first end 38 of the insulating member along a portion thereof. The spaced slices 46 may extend the full length of the insulating member 30 to a location adjacent a second end 40, if desired. The spaced slices 46 extend through the wall 42 of the tubular member 32 to the opening 34 thereby allowing the first and second ends 38, 40 to be pulled apart following installation of the insulating member 30 on the elongated handle cable 16, to thereby increase the length of the member and, consequently, increase its insulating coverage on the elongated member. In an embodiment, the spaced slices 46 may be located sequentially in 180 degree circumferential offsets. Other configurations are contemplated. In an embodiment, the increase in length may be greater than 2 times the original length. In another embodiment, the increase in length may be greater than 2.5 times the original length.

As the ends 38, 40 of the tubular member 32 of the insulating member 30 are drawn apart, the diameter of the opening 34 may be reduced about the elongated handle cable 16, thereby ensuring a snug fit thereabout and preventing the insulating member 30 from returning to its original configuration. Additionally, the first and second ends 38, 40 may be fixed in position following elongation using mechanical fasteners (not shown) or an adhesive.

In embodiments the insulating member 30 may be constructed of any suitable material that is easily deformed in a manner that will allow elongation of the sliced tubular member 32 following its installation onto an elongated member such as the elongated handle cable of the present example. Such materials may include rubber, foam, plastic, composite, etc.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed, but that the invention will include all embodiments falling within the scope of the application.

1. A door assembly for a motor vehicle comprising:
a door inner panel;
a trim panel;
an elongated handle cable extending between the door inner panel and the trim panel;
an insulating member installed over the elongated handle cable and comprising a tubular member having a wall defining an opening, for the insertion of the elongated handle cable, and a helical slice extending from adjacent a first end of the insulating member along a portion thereof, said helical slice configured to allow the first and second ends to be pulled apart to increase the length of the tubular member.

2. The door assembly of claim 1, wherein the helical slice extends through the wall of the tubular member and to the opening.

3. The door assembly of claim 1, wherein the helical slice extends the full length of the insulating member to a location adjacent a second end.

4. The door assembly of claim 1, wherein the increase in length is greater than 2 times the original length.

5. The door assembly of claim 1, wherein the increase in length is greater than 2.5 times the original length.

6. The door assembly of claim 1, wherein the insulating member is constructed of a material that is easily deformed in a manner that will allow elongation of the sliced tubular member following its installation onto the elongated handle cable.

7. The door assembly of claim 6, wherein the material comprises one of rubber, foam, plastic or composite.

8. An insulator for an elongated member having a first, proximate end and a second, distal end comprising:
a tubular member having a wall defining an opening, for the insertion of the elongated member, and at least one helical slice extending from adjacent a first end of the tubular member along a portion thereof, said slice configured to allowing the first and second ends to be pulled apart to increase the length of the tubular member.

9. (canceled)

10. The insulator of claim 8, wherein the helical slice extends the full length of the tubular member to a location adjacent a second end.

11. The insulator of claim 10, wherein the increase in length is greater than 2 times the original length.

12. The insulator of claim 10, wherein the increase in length is greater than 2.5 times the original length.

13. The insulator of claim 8, wherein the at least one slice comprises spaced slices extending from adjacent a first end of the insulating member along a portion of said tubular member.

14. The insulator of claim 13, wherein the spaced slices extend the full length of the tubular member to a location adjacent a second end.

15. The insulator of claim 13, wherein the, the spaced slices are located sequentially in 180 degree circumferential offsets.

16-20. (canceled)
